(19) United States
(12) Patent Application Publication
(10) Pub. No.: US 2006/0126277 A1
(43) Pub. Date: Jun. 15, 2006

(54) Modular power supply

(76) Inventor: Glen Tomkowiak, St. Clair Shores, MI (US)

Correspondence Address: BRIAN L. RIBANDO;REISING, ETHINGTON, BARNES, KISSELLE, P.C., P. O. BOX 4390, TROY, MI, 48099, US

(21) Appl. No.: 11/010,608

(22) Filed: Dec. 13, 2004

(51) Int. Cl. H02B 1/00

(52) U.S. Cl. 361/601

(57) ABSTRACT

A power supply apparatus is adapted for use in an electrical cabinet and includes at least one input module and at least one output module positioned adjacent with respect to the input module and electrically connected in series to the input module. The output module(s) may be serially connected to one another, and frictionally interengaged by retainer features and electrical connectors.

### FIELD OF THE INVENTION

This invention relates generally to electrical systems and devices, and more particularly to a mounting assembly for electrical power distribution.

### BACKGROUND OF THE INVENTION

Power supplies are widely used in products, such as computers, and in manufacturing environments, such as in an electrical cabinet of a transfer line. A typical manufacturing transfer line includes several different machines that perform successive operations on a workpiece that is transferred from one station of the line to the next. Each of the stations of the transfer line typically may include motors, welding guns, resistance heating elements, and other related equipment such as computers, gages, lighting, station control panels, and the like. The various equipment or devices may require different voltage levels from various power transformers.

Separately derived power is generally supplied and distributed to stations of a transfer line from a master electrical panel or cabinet. The control panel is often coupled to a source of three-phase, 480 volt power, such as from a utility power line or a plant powerhouse. A conventional master electrical panel usually contains a wide variety of system electrical and electronic devices such as fuse blocks, circuit breakers, communications devices, terminal blocks, motor drives, and power transformers to name a few. The electrical panel may contain a number of individual power supplies that provide the different voltage levels required by the various station devices of the transfer line.

The power supplies are of various unique sizes and shapes and are often spread out in various locations throughout the control panel. Oftentimes, voltage level requirements of a transfer line station change and an additional transformer has to be added to the master electrical panel. To make space for the change, the existing transformers and other devices must be physically demounted from the panel, moved, perhaps rewired, and remounted in another location within the panel. Such rework of an electrical panel is time-consuming, costly, and ultimately unnecessary.

Previous attempts at modularizing electrical devices are inadequate. Many such attempts mandate the use of mounting rails and exposed bus bars connected to electrical modules: a practice that is not absolutely necessary. Therefore, prior art electrical modules are not fully optimized for simplicity, flexibility, and expandability.

### SUMMARY OF THE INVENTION

An exemplary embodiment of the present invention includes a power supply apparatus including at least one input module and at least one output module positioned adjacent with respect to the input module. The output module is electrically connected in series to the input module. A preferred aspect of this embodiment includes a plurality of output modules and an end cap module mounted to one of the output modules.

Another exemplary embodiment of the present invention includes an electrical apparatus adapted for use within an electrical cabinet. The electrical apparatus includes a plurality of power supply modules, which includes at least one input module and at least one output module. The input module is provided for receiving and supplying power to the output module, wherein the input module includes a plurality of output connectors. The output module is mounted adjacent with respect to the input module and includes a plurality of input connectors adapted for connection to the output connectors of the input module.

A further exemplary embodiment of the present invention includes an electrical apparatus adapted for supplying power to a plurality of power consuming devices. The electrical apparatus includes an electrical cabinet and a plurality of power supply modules located in the electrical cabinet. The power supply modules includes an input module and a plurality of output modules. The input module receives and supplies line power to the output modules, and includes a plurality of output connectors. The output modules are electrically connected in series to communicate or supply power to the power consuming devices and are mounted adjacent with respect to the input module. The output modules include a plurality of output connectors and a plurality of input connectors adapted for connection to at least one of the output connectors of the input module and output connectors of adjacent output modules.

At least some of the objects, features and advantages that may be achieved by at least certain embodiments of the invention include providing power supplies that are readily adaptable to various electrical or electronic applications including computers, industrial electrical cabinets, and the like; power supplies that may be centralized in a predetermined location within a cabinet to save space therein; a power supply assembly that is composed of modular power supplies to enable flexibility and expandability of the assembly without labor-intensive use of tools or separate fasteners; a power supply assembly that includes modular power supplies of varying size and capable of delivering various voltage outputs; power supply modules that include integrated transformers and electrical overload protectors therein; and a modular power supply assembly that is powered in series and may obviate the need for a separate, exposed busbar to power individual output modules; all of which are of relatively simple design and economical manufacture and assembly, are reliable and have long, useful service lives.

Of course, other objects, features and advantages will be apparent in view of this disclosure to those skilled in the art. Various other environments, such as computer cabinets or housings, embodying the invention may achieve more or less than the noted objects, features or advantages.

### BRIEF DESCRIPTION OF THE DRAWINGS

These and other objects, features and advantages of the present invention will be apparent from the following detailed description of the preferred embodiments and best mode, appended claims, and accompanying drawings in which:

FIG. 1 is an elevational view of an open electrical cabinet of an electrical apparatus according to an exemplary embodiment of the present invention;

FIG. 2 is an enlarged elevational view of a portion of the electrical apparatus of FIG. 1;

FIG. 3 is a schematic view of a portion of the electrical apparatus of FIG. 2;

FIG. 4 is an enlarged side view of a portion of the electrical apparatus of FIG. 2;

FIG. 5 is an enlarged elevational view of a portion of an electrical apparatus according to another exemplary embodiment of the present invention; and

FIG. 6 is an enlarged cross-sectional view of the electrical apparatus of FIG. 5.

### DETAILED DESCRIPTION OF THE PREFERRED EMBODIMENTS

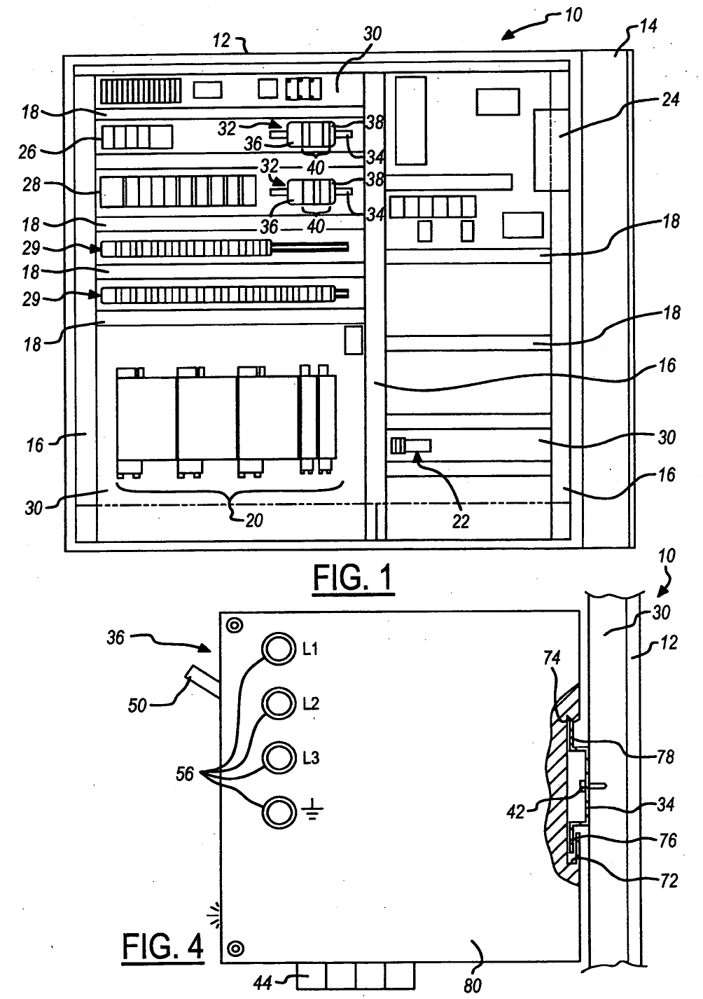

Referring in detail to the drawings, FIG. 1 illustrates an electrical apparatus 10 including an electrical cabinet 12 shown with a door 14 open and to expose the inside of the electrical cabinet 12, which includes bays defined by vertical and horizontal dividers 16, 18. The electrical apparatus 10 may include various electrical devices, such as motor drives 20, a terminal rail 22, an isolator/disconnect 24, relays 26, PLC or I/O couplers 28, short-circuit ground-fault overcurrent devices 29 such as fuses and circuit breakers, and the like. The electrical apparatus 10 also includes one or more sub-plates 30 mounted to the back of the electrical cabinet 12 for mounting the various electrical devices thereto.

Moreover, the electrical apparatus 10 includes modular power supply assemblies 32 according to embodiments of the present invention. The modular power supply assemblies 32 supply power to one or more power consuming devices such as motors, welding guns, resistance heating elements, computers, gages, lighting, station control panels, fans, control cards, and the like. The modular power supply assemblies 32 are preferably mounted to the sub-plate 30 using a mounting rail 34 such as a 35 mm DIN rail, or the like. The modular power supply assemblies preferably include a base or input module 36, an end cap module 38, and one or more power supply or output modules 40 electrically connected in series with one another and with the input module 36.

One or both of the modular power supply assemblies 32 may be centralized, as shown. Conventional electrical cabinet arrangements, however, often have decentralized power supplies that are distributed throughout the entire cabinet in various bays thereof. Such a conventional arrangement may be used to supply power locally to devices in respective bays or to devices outside the electrical cabinet, and such decentralized power supplies are typically added in any convenient location where there is free space. In contrast, the modular power supply assemblies 32 of the present invention are preferably centralized in one location within the electrical cabinet 30 or at least within one or more dedicated bays as shown. Furthermore, the power supply assemblies 32 may be grouped by function such AC vs. DC voltage supply, power consuming devices that are internal to the cabinet vs. external with respect thereto, and the like.

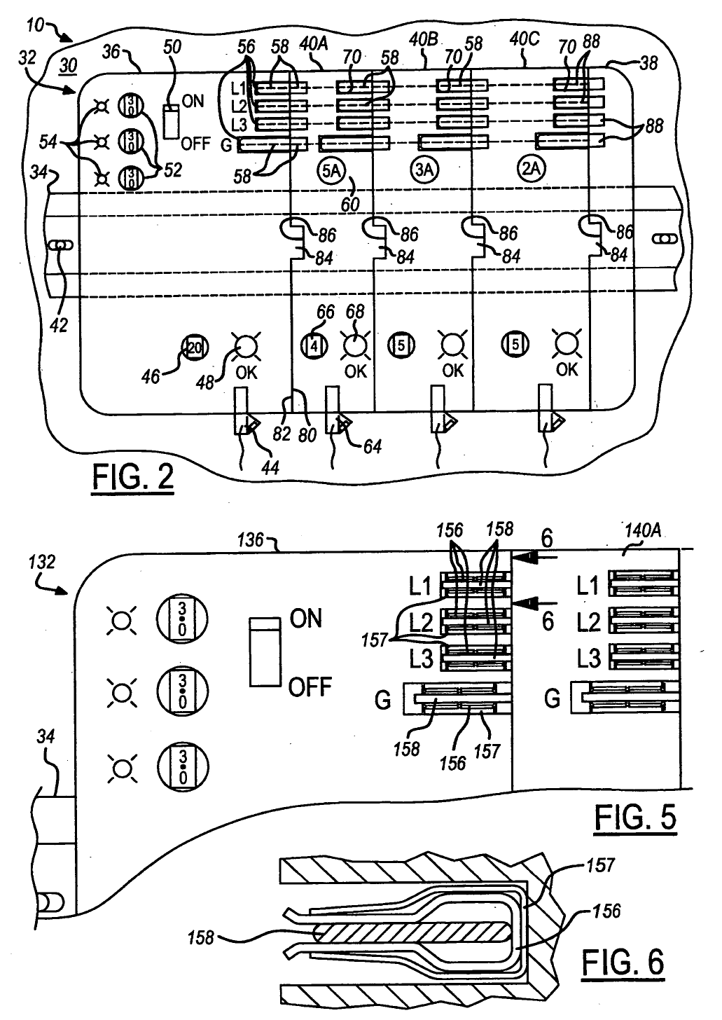

FIG. 2 illustrates an exemplary modular power supply assembly 32 of the electrical apparatus 10 of the present invention, wherein the assembly 32 is mounted to the sub-plate 30 by the DIN rail 34, which may be retained thereto by fasteners 42 such as pins, screws, or the like. The assembly 32 includes the input module 36, the end cap 38, and three output modules 40A, 40B, 40C therebetween as an exemplary quantity.

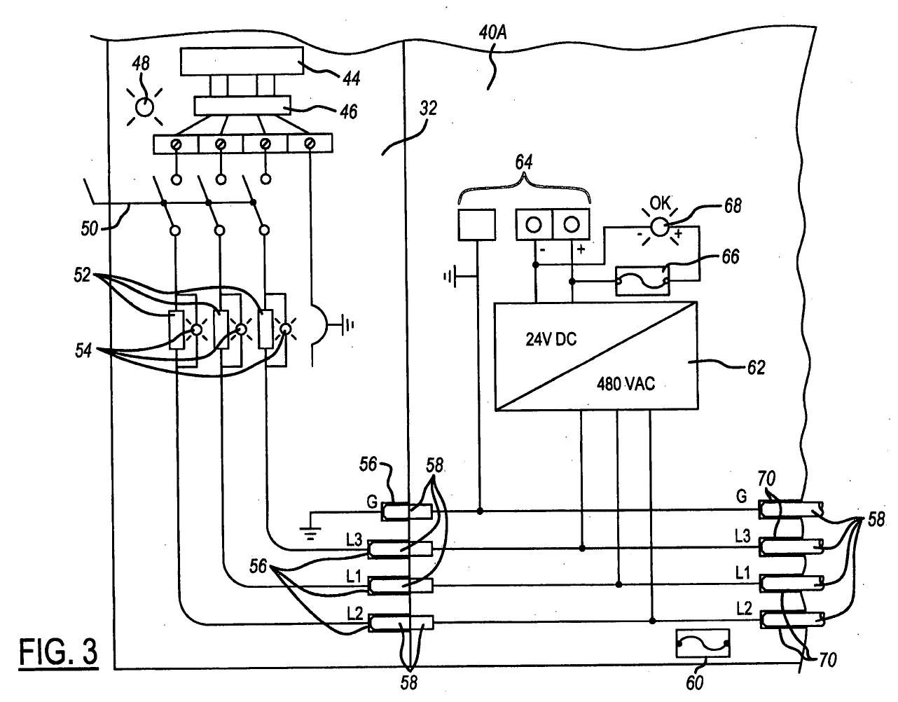

As shown in FIG. 2 and in the corresponding schematic of FIG. 3, the input module 36 includes an input terminal 44, such as a Phoenix connector, for receiving electricity, or line power, from a power source (not shown) such as a utility powerline, a plant powerhouse, a generator, or the like. For example, the electrical line power received by the input module 36 through the input terminal 44 may, for example, be 480 volt, three-phase power. The input module 36 further includes a secondary electrical protection device 46 such as a circuit breaker or a Bussman® 600 Volt fuse and fuseholder, and a related indicator light 48 in circuit with the input terminal. The power in each of phase lines L1, L2, L3 may be controlled by a switch or disconnect 50, just upstream of individual primary electrical protection devices 52, such as a circuit breaker or a Bussman® HPF 600 Volt fuseholders and fuses, and related indicator lights 54. If the protection devices 52 fail and open, then all applied voltage is across the indicator lights 54. Thereafter, the phase lines G, L1, L2, L3 are connected to electrical conductors or output connectors 56, such as sleeve connectors. Any suitable connectors may be used, including pin and sleeve style connectors that are custom manufactured or commercially available for example from Leviton, Arrow Hart, Pass and Seymour, and the like.

Still referring to FIGS. 2 and 3, the phase lines G, L1, L2, and L3 extend such that the sleeve connectors 56 connect to electrical conductors or input connectors 58, such as pin connectors of the first output module 40A. The connectors 56, 58 preferably frictionally interengage to further support the mounting of the output modules 40 to one another and to the input module 36. Those of ordinary skill in the relevant art will recognize that the connectors 56, 58 can be reversed such that the pin connectors 58 are part of the input module 36 and the sleeve connectors 56 are part of the output module 40A. The present invention also contemplates that the plurality of connectors 56, 58, 70 in each module 36, 40A, 40B, 40C is equivalent to a single electrical connector that integrates all of the pins and sleeves into one device. In either case, the pin connectors 58 communicate with a primary fuse 52 of the input module 36 and/or fuses 60 of the individual output modules 40A-C. Those of ordinary skill in the art will recognize that hidden lines are used in the drawings to show conductive interconnections between various portions of the hardware disclosed herein.

Line G connects to ground, wherein the connectors 56, 58 of line G are dimensioned so as to engage before the connectors of phase lines L1, L2, L3 to provide a first make, last break style ground. The Phase lines L1, L2, L3 connect to a transformer 62, such as a 480 V AC to 24 V DC step down transformer as shown. Any suitable transformer may be used to achieve any desired output voltage such as 380 V AC, 277 V AC, 240 V AC, 220 V AC, 230 V AC, 110 V AC, 48 V DC, 24 V DC, 15 V DC, 12 V DC, 5 V DC, and the like. The transformer 62 enables the output module(s) to output power that is different in one or more respects from the line power received by the input module 36. If, however, a power consuming device requires 480 Volt, 3 phase power, then one of the modules may omit a transformer and instead just include one or more fuses, electrical signal filters, or the like. For that matter, any of the modules may instead, or additionally, include electrical equipment other than fuses and transformers, such as electrical signal filters, power conditioners, and the like. The transformer 62 connects to an output terminal 64 via a secondary fuse 66 and a related indicator light 68. Phase lines G, L1, L2, and L3 (shown in hidden lines) of the output module 40A also connect to respective electrical conductors or output connectors 70, such as sleeve connectors, of the output module 40A.

In turn, the sleeve connectors 70 connect to pin connectors 58 of the next adjacent output module or intermediate output module 40B, which is schematically similar to the first output module 40C but may have a different transformer for outputting a different voltage level, or may have different fuses for establishing different electrical protection thresholds, or the like. Accordingly, the intermediate output module 40B may be, for example, larger in at least one dimension than an adjacent output module, such as the first output module 40A. As shown, the intermediate output module 40B is wider than the first output module 40A so as to accommodate a larger transformer or a larger fuse or both. Although it is preferred, those of ordinary skill in the art will recognize that the modules 40A, 40B, 40C do not have to be identical in height as shown or identical in depth (e.g. in a direction perpendicular to the height dimension and to the plane established by the sub-plate: i.e. into the drawing sheet). Rather, each of the modules 40A, 40B, 40C may be sized differently to accommodate different electrical and/or electronic components therein—just as long as the connectors 58, 70 are provided so as to align with respective connectors 58, 70 of adjacent modules.

FIG. 4 illustrates a schematic side view of the input module 36 as an example of how the apparatus 10 may be assembled. In one example, the sub-plate 30 may be mounted to the electrical cabinet 12 in any desired manner known to those of ordinary skill in the art. In turn, the module 36 may be mounted to the sub-plate 30 in any desired manner known to those of ordinary skill in the art, such as via a snap-on connection to the DIN rail 34, which may be a “top hat” DIN rail (standard EN 50022-35). The module 36 includes a mounting channel at least partially defined by a lower groove 72 and an upper groove 74 that cooperate respectively with lower and upper flanges 76, 78 of the DIN rail 34. The module 36 is preferably interengaged to the DIN rail 34, preferably by a snap-fit. Accordingly, the lower flange 76 of the DIN rail 34 is introduced into the lower notch 72 of the module 36, which is then pivoted about the lower flange 76 until the upper flange 78 snaps into the upper groove 74 of the module 36. Once the module 36 is snap fit, or mounted, to the DIN rail 34, the module 36 can be slid sideways along the rail 34 to any desired location. Each of the other modules 38, 40A, 40B, 40C may be similarly constructed and assembled to the DIN rail 34.

Referring again to FIG. 2, once the input module 36 is assembled to the DIN rail 34 and placed in a desired location, the first output module 40A may be similarly snap fit to the DIN rail 34 and slid along the rail 34 toward the input module 36 at least until the connectors 56, 58 engage and preferably until sides 80, 82 of the modules 36, 40A are at least adjacently disposed, or more preferably, come into contact. The connectors 56, 58 alone, or in combination with the DIN rail 34, may provide sufficient holding force to hold the modules 36, 40A in place. In other words, the connectors 56, 58 may be designed to obviate the need for the DIN rail 34. In addition, each module 36, 38, 40A, 40B, 40C may be provided with interengaging retainer features such as a tab 84 and slot 86 arrangement as shown. The retainer features may be designed to be interlocking snap fit features, frictionally interengaged features, or the like. In this case, for example, the first output module 40A is preferably slid along the DIN rail 34 toward the input module 36 until the connectors 56, 58 engage and the retainer features 84, 86 likewise interengage such that the tab 84 of the input module frictionally fits into the slot 86 of the first output module 40C.

The same applies for each subsequent module 40B, 40C, 38. For example, the second output module 40B may be snapped to the DIN rail 34 and slid toward the first output module 36 until the respective connectors 58, 70 engage and the tab 84 of the first output module 40A frictionally fits into the slot 86 of the second output module 40B. Alternatively, the retainer features 84, 86 may be designed such that they are capable of supporting the entire assembly 32 without use of the DIN rail 34, either alone or in combination with the holding force supplied by the frictionally interengaged connectors 58, 70. In such a case, the input module 36 could be fastened directly to the sub-plate 30 and the rest of the modules 40A, 40B, 40C, 38 could be serially assembled to the input module 36. Those of ordinary skill in the art will recognize that any suitable snap fit, interlocking, or otherwise interengaging retention features may be substituted for that depicted in FIG. 2. After all of the output modules 40A, 40B, 40C, etc. have been assembled, the end cap 38 is similarly snap fit to the DIN rail 34 and slid toward the last output module (e.g. 40C) and retained thereto by the tab 84 and slot 86 retainer features. Additionally, the end cap 38 may also include non-conducting pins 88 that connect to the respective sleeves 70 of the last output module 40C for additional holding force, such as where the DIN rail 34 is not used.

Accordingly, modification of the power supply module assembly 32 is relatively easy. For example, if it is desired to add another output module (not shown), the end cap 38 is simply pulled away from the last output module until the frictional interengagement of the retainer features 84, 86 and the connectors 58, 70 is overcome such that the end cap 38 may be slid along the rail 34. Thereafter, the new module is snap fit to the DIN rail 34 and slid into engagement with the last output module 40C, and the end cap 38 is slid into engagement with the newly added output module. It is not necessary to drill holes in the sub-plate 30 to separately mount the new module, nor is it necessary to search for a suitable location and rearrange other devices to accommodate the new module. Rather, the new module is quickly and simply snap fit in its predetermined place along the mounting rail in a predesignated bay of the electrical cabinet without any special individualized mounting.

FIGS. 5 and 6 illustrate another exemplary embodiment of the present invention. This embodiment is similar in many respects to the embodiment of FIGS. 2 through 4 and like numerals between the embodiments generally designate like or corresponding elements throughout the several views of the drawing figures. Therefore, the common subject matter will generally not be repeated here.

FIG. 5 illustrates a modular power supply assembly 132 including an input module 136 and a first output module 140A assembled thereto. The input module 136 includes conductors or output connectors 156, such as sockets, that accept input connectors 158, such as blades, of the first output module 140A. FIG. 6 depicts an exemplary connector arrangement in cross section. Here it can be seen that the connection includes the U-shaped socket 156 and the blade 158 disposed therein and forcibly retained therein by a U-shaped spring 157. The U-shaped 157 spring may be composed of a high strength spring steel and the blade 158 and U-shaped socket 156 may be composed of a highly electrically conductive material such as copper. In assembly, the input module 136 is preferably snapped to the DIN rail 34 as described with regard to the embodiment of FIGS. 2-4. Thereafter, the output module 140A is preferably snapped to the DIN rail 34 and directly into engagement with the input module 136, without having to slide the output module 140A along the rail 34, such that the blades 158 fit into their respective sockets 156. The same sequence may be repeated for additional output modules and an end cap (not shown).

While the forms of the invention herein disclosed constitute a presently preferred embodiment, many others are possible. For instance, the present invention may be deployed in other environments including computer cabinets, and the like. It is not intended herein to mention all the possible equivalent forms or ramifications of the invention. It is understood that terms used herein are merely descriptive, rather than limiting, and that various changes may be made without departing from the spirit and scope of the invention as defined by the following claims.

What is claimed is:

1. An electrical apparatus adapted for mounting within an electrical cabinet, said electrical apparatus comprising:
a plurality of power supply modules including at least one input module and at least one output module powered in series with said at least one input module, said at least one input module including a plurality of output connectors, said at least one output module being mounted adjacent said at least one input module, said at least one output module including a plurality of input connectors adapted for connection to said plurality of output connectors of said at least one input module.

2. The electrical apparatus of claim 1 wherein said at least one output module includes a plurality of output modules electrically connected to one another in series, each of said plurality of output modules includes said plurality of input connectors and further includes a plurality of output connectors in electrical communication with said plurality of input connectors, said plurality of output connectors of any given one of said plurality of output modules being adapted for connection to a respective plurality of input connectors of an adjacent output module of said plurality of output modules.

3. The electrical apparatus of claim 1 wherein said plurality of input connectors includes a plurality of pin connectors and said pluralities of output connectors includes a plurality of sleeve connectors.

4. The electrical apparatus of claim 1 wherein said plurality of input connectors includes a plurality of blade connectors and said pluralities of output connectors includes a plurality of socket connectors.

5. The electrical apparatus of claim 1 wherein said plurality of power supply modules include interengaging features for mechanically connecting said power supply modules together.

6. The electrical apparatus of claim 1 further comprising a mounting rail mounted within said electrical cabinet and adapted for mounting at least one of said plurality of power supply modules thereto.

7. The electrical apparatus of claim 1 wherein said plurality of input connectors and said plurality of output connectors frictionally interengage to provide mounting support among said plurality of power supply modules.

8. The electrical apparatus of claim 1 wherein said at least one input module includes at least one input terminal and further wherein said at least one output module includes at least one output terminal.

9. The electrical apparatus of claim 1 wherein said at least one output module includes at least one of at least one transformer and at least one electrical protective device therein.

10. The electrical apparatus of claim 1 further comprising an end cap module mounted to one of said at least one output module.

11. An electrical apparatus adapted for supplying power to a plurality of power consuming devices, said electrical apparatus comprising:
an electrical cabinet; and
a plurality of power supply modules located in said electrical cabinet and including an input module and electrically connected in series to a plurality of output modules, said input module for receiving and supplying line power to said plurality of output modules, said input module including a plurality of output connectors, said plurality of output modules being electrically connected in series and communicating power to said plurality of power consuming devices, said plurality of output modules being positioned adjacent said at least one input module, said plurality of output modules including a plurality of output connectors and a plurality of input connectors adapted for connection to at least one of said plurality of output connectors of said at least one input module and said plurality of output connectors of adjacent output modules of said plurality of output modules.

12. The electrical apparatus of claim 11 wherein said plurality of output modules are adapted to provide at least two different voltage levels to said power consuming devices.

13. The electrical apparatus of claim 11 wherein said plurality of input connectors includes a plurality of pin connectors and said pluralities of output connectors include a plurality of sleeve connectors.

14. The electrical apparatus of claim 11 wherein said plurality of input connectors includes a plurality of blade connectors and said pluralities of output connectors include a plurality of socket connectors.

15. The electrical apparatus of claim 11 wherein said plurality of power supply modules include interengaging features for mechanically connecting said power supply modules together.

16. The electrical apparatus of claim 11 further comprising a mounting rail mounted within said electrical cabinet and adapted for mounting at least one of said plurality of power supply modules thereto.

17. The electrical apparatus of claim 11 wherein said plurality of input connectors and said plurality of output connectors frictionally interengage to provide mounting support among said plurality of power supply modules.

18. The electrical apparatus of claim 11 wherein said at least one input module includes at least one input terminal and further wherein said at least one output module includes at least one output terminal.

19. The electrical apparatus of claim 11 wherein said at least one output module includes at least one of at least one transformer and at least one electric protective device therein.

20. The electrical apparatus of claim 11 further comprising an end cap mounted to said at least one power supply module.

21. A power supply apparatus comprising:
at least one input module; and
at least one output module positioned adjacent said at least one input module and being electrically connected in series to said at least one input module.

22. The power supply apparatus of claim 21 wherein said plurality of power supply modules include interengaging features for mechanically connecting said power supply modules together.

23. The power supply apparatus of claim 21 further comprising a mounting rail mounted to said electrical cabinet and adapted for mounting at least one of said plurality of power supply modules thereto.

24. The power supply apparatus of claim 21 wherein said at least one output module includes a plurality of output modules connected in series.

25. The power supply apparatus of claim 21 further comprising an end cap mounted to said at least one power supply module.
